(19) United States
(12) Patent Application Publication
(10) Pub. No.: US 2016/0277821 A1
(43) Pub. Date: Sep. 22, 2016

(54) VIBRATION HEADPHONES

(71) Applicant: Panasonic Intellectual Property Management Co., Ltd., Osaka (JP)

(72) Inventor: Hiroshi KUNIMOTO, Osaka (JP)

(21) Appl. No.: 15/057,360

(22) Filed: Mar. 1, 2016

(30) Foreign Application Priority Data
Mar. 19, 2015 (JP) 2015-056491
Dec. 16, 2015 (JP) 2015-244774

(51) Int. Cl. H04R 1/10; H04R 3/08

(52) U.S. Cl. CPC H04R 1/10; H04R 3/08; H04R 2400/03

(57) ABSTRACT

Vibration headphones of the present technology include a first housing including an electroacoustic transducer configured to output a sound wave that is generated based on an audio signal fed to a first channel (right channel) and a first vibration driver configured to vibrate by converting an audio signal into mechanical vibration, and a second housing including an electroacoustic transducer configured to output a sound wave that is generated based on an audio signal in a second channel (left channel) and a second vibration driver configured to vibrate by converting an audio signal into mechanical vibration. Resonant frequencies of the first and the second vibration drivers are set in such a way that, when both the first and the second vibration drivers vibrate, at least two resonant frequencies appear in the vibrations of the first and the second vibration drivers.

### BACKGROUND

1. Technical Field

The present disclosure relates to headphones for transferring, to a user, sound reproduced based on an audio signal and vibration generated based on an audio signal.

2. Description of the Related Art

Unexamined Japanese Patent Publication No. S63-86997 discloses a structure for giving the feel of reality by including an acoustic transducer device for converting an audio signal into sound, and a structure for bone conduction for converting an audio signal into mechanical vibration and directly transmitting the vibration to the auditory nerve.

### SUMMARY

Vibration headphones according to the present disclosure include a first housing including a first electroacoustic transducer configured to output a sound wave that is generated based on an audio signal fed to a first channel, and a first vibration unit configured to vibrate by converting an audio signal into mechanical vibration, and a second housing including a second electroacoustic transducer configured to output a sound wave that is generated based on an audio signal in a second channel, and a second vibration unit configured to vibrate by converting an audio signal into mechanical vibration. Resonant frequencies of the first vibration unit and the second vibration unit are set in such a way that, when both the first vibration unit and the second vibration unit vibrate, at least two resonant frequencies appear in vibrations of the first vibration unit and the second vibration unit.

The vibration headphones according to the present disclosure have a configuration where vibration which is generated by a spring that is embedded in a vibration driver fixed to a right housing reaches a left housing via a headband, and vibration which is generated by a spring that is embedded in a vibration driver fixed to the left housing reaches the right housing via the headband.

### BRIEF DESCRIPTION OF DRAWINGS

FIG. 1 is an appearance diagram of vibration headphones according to a first exemplary embodiment;

FIG. 2 is a cross-sectional diagram showing configurations inside housings of the vibration headphones according to the first exemplary embodiment;

FIG. 3 is a block diagram showing a configuration of an electrical circuit of the vibration headphones according to the first exemplary embodiment;

FIG. 4A is a diagram showing, with respect to conventional vibration headphones, frequency characteristics of a vibration level in a case where a signal is fed only to a left channel;

FIG. 4B is a diagram showing, with respect to the conventional vibration headphones, frequency characteristics of a vibration level in a case where a signal is fed only to a right channel;

FIG. 4C is a diagram showing frequency characteristics of vibration levels of the conventional vibration headphones;

FIG. 5 is a diagram for describing measurement points for frequency characteristics of vibration levels;

FIG. 6A is a diagram showing, with respect to the vibration headphones according to the first exemplary embodiment, frequency characteristics of a vibration level in a case where a signal is fed only to a left channel;

FIG. 6B is a diagram showing, with respect to the vibration headphones according to the first exemplary embodiment, frequency characteristics of a vibration level in a case where a signal is fed only to a right channel;

FIG. 6C is a diagram showing frequency characteristics of vibration levels of the vibration headphones according to the first exemplary embodiment;

FIG. 7A is a diagram showing a vibration driver of a right housing of a first example configuration;

FIG. 7B is a diagram showing the vibration driver of the right housing of the first example configuration;

FIG. 7C is a diagram showing a vibration driver of a left housing of the first example configuration;

FIG. 7D is a diagram showing the vibration driver of the left housing of the first example configuration;

FIG. 8A is a diagram showing a vibration driver of a right housing of a second example configuration;

FIG. 8B is a diagram showing the vibration driver of the right housing of the second example configuration;

FIG. 8C is a diagram showing a vibration driver of a left housing of the second example configuration;

FIG. 8D is a diagram showing the vibration driver of the left housing of the second example configuration;

FIG. 9A is a diagram showing a vibration driver of a right housing of a third example configuration;

FIG. 9B is a diagram showing the vibration driver of the right housing of the third example configuration;

FIG. 9C is a diagram showing a vibration driver of a left housing of the third example configuration;

FIG. 9D is a diagram showing the vibration driver of the left housing of the third example configuration;

FIG. 10 is a diagram showing a vibration driver of a fourth example configuration;

FIG. 11 is a diagram showing frequency characteristics of a vibration level of the vibration driver of the fourth example configuration;

FIG. 12 is a diagram showing a vibration driver of a fifth example configuration; and

FIG. 13 is a diagram showing frequency characteristics of a vibration level of the vibration driver of the fifth example configuration.

### DETAILED DESCRIPTION

Hereinafter, exemplary embodiments will be described in detail with reference to the drawings as appropriate. However, unnecessarily detailed description may be omitted. For example, detailed description of already well-known matters and repeated description of substantially the same structure may be omitted. All of such omissions are intended to facilitate understanding by those skilled in the art by preventing the following description from becoming unnecessarily redundant. Moreover, the applicant provides the appended drawings and the following description for those skilled in the art to fully understand the present disclosure, and does not intend the subject described in the claims to be limited by the appended drawings and the following description.

The inventor(s) of the present invention has/have found, upon listening to various music sources, such as movies, music and games, with conventional headphones, that the heavy bass sound and the feel of reality such as those felt in movie theaters and concert venues are not sufficiently felt. Also, the inventor(s) of the present invention has/have analyzed, in particular, low-frequency sounds of music of movies, games and the like, and has/have found that the levels of sounds at specific frequencies such as 60 Hz and 80 Hz are sometimes high. Also, when analyzing conventional headphones including an acoustic transducer device for converting an audio signal into sound, and a structure (vibration driver) for bone conduction for converting an audio signal into mechanical vibration and directly transmitting the vibration to the auditory nerve, the inventor(s) of the present invention has/have found that the frequency band is narrow for vibration for bone conduction. The inventor(s) of the present invention has/have devised headphones of the present disclosure described below based on these findings.

### First Exemplary Embodiment

Hereinafter, an exemplary embodiment will be described with reference to the appended drawings.

### 1. Configuration and Operation of Vibration Headphones

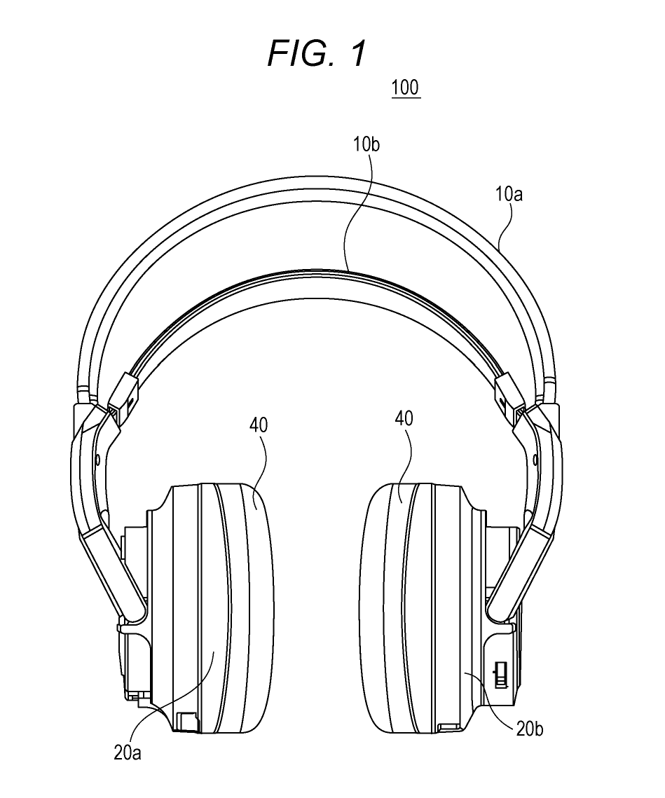

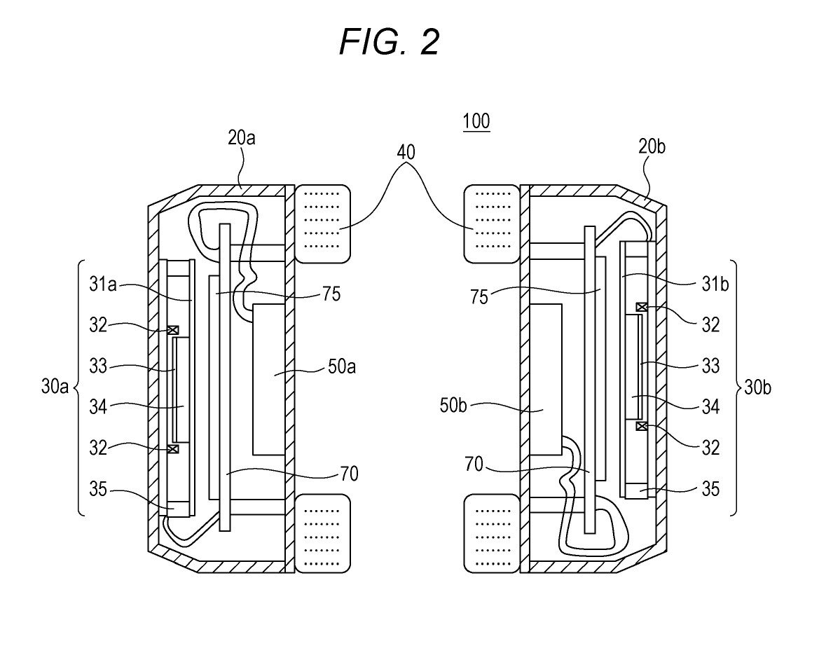

Vibration headphones of the present exemplary embodiment are headphones for transferring, to a user, sound reproduced based on an audio signal and vibration generated based on an audio signal. FIG. 1 is an appearance diagram of vibration headphones (hereinafter referred to as “headphones”) 100 according to the first exemplary embodiment. Also, FIG. 2 is a cross-sectional diagram showing configurations inside housings of vibration headphones 100.

Headphones 100 are overhead headphones having right housing 20a and left housing 20b linked together by hard headband 10a. Also, headphones 100 are mounted on a head by headband 10b.

Housings 20a, 20b respectively accommodate electroacoustic transducers 50a, 50b for converting input audio signals into sound waves (vibration of air), and vibration drivers (vibration units) 30a, 30b for converting input audio signals into mechanical vibrations. Also, housings 20a, 20b each accommodate circuit board 70 on which electrical circuit 75 for signal processing is mounted.

Electroacoustic transducers 50a, 50b are devices (for example, speakers) which include diaphragms, not shown, and which are for converting input audio signals into sound waves (vibration of air) by vibrating the diaphragms based on the audio signals. The sound waves output from electroacoustic transducers 50a, 50b are to reach the eardrums of a user.

Vibration drivers 30a, 30b are electromagnetic vibration drivers for converting audio signals into mechanical vibrations. Vibration driver 30a, 30b is configured from coil 32 which an audio signal transmitted via a signal line, not shown, is to reach, magnet 33 that vibrates in the vertical direction according to fluctuations in the magnetic field caused by coil 32, weight 34 for adding a weight to magnet 33, spring (vibrator) 31a, 31b coupled with weight 34, and case 35. Case 35 accommodates magnet 33, coil 32, and weight 34. Moreover, case 35 transmits the mechanical vibration of magnet 33 to the outside via spring 31a, 31b. Spring 31a, 31b is a vibrator for generating vibration for bone conduction, and is configured by a leaf spring, for example. Vibration generated by vibration driver 30a, 30b is transmitted to the head of a user via ear pad 40 and headband 10a.

Additionally, in the following description, in the case of giving a description without distinguishing between left and right housings 20a, 20b, the reference numeral “20” is used for the housing. Likewise, in the case of giving a description without distinguishing between left and right vibration drivers 30a, 30b, the reference numeral “30” is used for the vibration driver. Also in the case of giving a description without distinguishing between springs 31a, 31b, the reference numeral “31” is used for the spring.

With headphones 100 of the present exemplary embodiment, vibration driver 30a attached to right housing 20a and vibration driver 30b attached to left housing 20b have different resonant frequencies. The vibration frequency band of the overall vibration headphones is thereby widened, as will be described later. The resonant frequency of vibration driver 30 may be set to a desired value by modifying the weights, the shapes and the like of structural elements (for example, spring 31, magnet 33, and weight 34) configuring the vibration driver.

Right housing 20a and left housing 20b are linked together by hard headband 10a. According to this configuration, vibration which is generated by spring 31a that is embedded in vibration driver 30a fixed to right housing 20a reaches left housing 20b via headband 10a. In the same manner, vibration which is generated by spring 31b that is embedded in vibration driver 30b fixed to left housing 20b reaches right housing 20a via headband 10a.

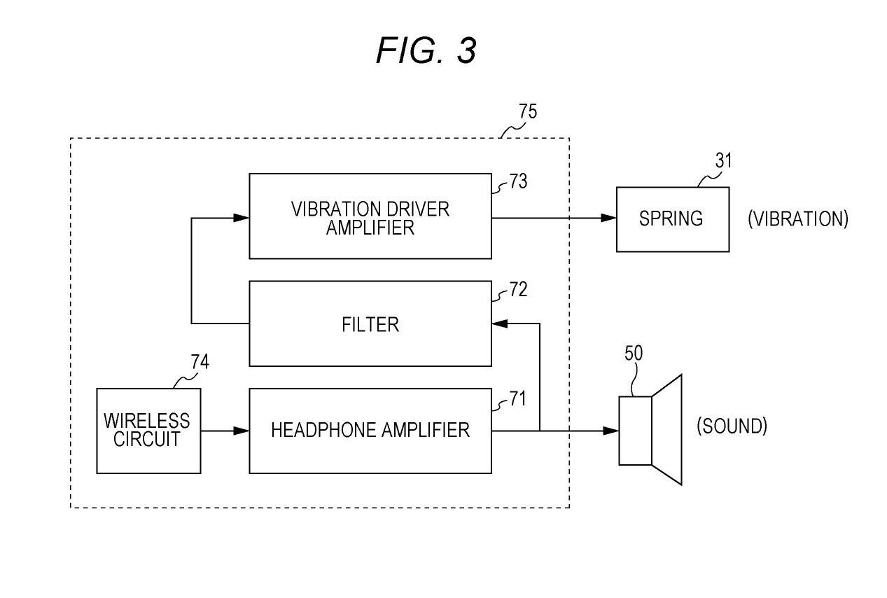

FIG. 3 is a block diagram showing a configuration of electrical circuit 75 of headphones 100. Electrical circuit 75 includes headphone amplifier 71, filter 72, vibration driver amplifier 73, and wireless circuit 74. Each of circuits 71 to 74 of electrical circuit 75 is mounted on circuit board 70. An output of headphone amplifier 71 is connected to electroacoustic transducer 50, and an output of vibration driver amplifier 73 is connected to spring 31 inside vibration driver 30.

### 2. Operation

An operation of headphones 100 configured in the above manner will be described.

Electrical circuit 75 inputs an audio signal based on an output of headphones of a music reproduction device such as a tablet terminal, a smartphone, a DVD player or a TV. Electrical circuit 75 generates a signal for driving spring 31 and electroacoustic transducer 50 based on the input audio signal.

Specifically, an audio signal transmitted from a music reproduction device such as a tablet terminal is received by wireless circuit 74, and is input to headphone amplifier 71. Wireless circuit 74 here is a circuit for performing communication according to communication standards such as WiFi or Bluetooth (registered trademark).

Headphone amplifier 71 amplifies the audio signal input from wireless circuit 74, and outputs the signal to electroacoustic transducer 50. Electroacoustic transducer 50 reproduces (outputs) audio based on the amplified signal.

The output signal of headphone amplifier 71 is also input to filter 72. Filter 72 passes a signal having a frequency equal to or lower than a predetermined frequency. In the present exemplary embodiment, filter 72 is configured by a low-pass filter (LPF) that removes (blocks) signals higher than 100 Hz. A signal having a frequency equal to or lower than 100 Hz which has passed through filter 72 is input and amplified at vibration driver amplifier 73, and is input to spring 31.

Spring 31 vibrates based on the output signal from vibration driver amplifier 73. In this manner, when an audio signal of a heavy bass sound having a frequency equal to or below 100 Hz is input to vibration driver amplifier 73, spring 31 is vibrated. Vibration of spring 31 is transmitted to the head of a user via ear pad 40 and headband 10a of headphones 100. The user may experience powerful sound by physically experiencing the vibration of spring 31 together with the audio reproduced by electroacoustic transducer 50.

As described above, vibration driver amplifier 73 amplifies a low-frequency audio signal extracted by filter 72, and outputs the signal to vibration driver 30. Vibration driver 30 vibrates when a signal having a low frequency (for example, 50 Hz to 100 Hz) is input. Vibration driver 30 vibrates in synchronization with the sound to which the user is listening.

Accordingly, the sound and the vibration reach the brain of the user at the same timing, and the user is allowed to experience the heavy bass sound and the feel of reality compared to a case of listening to only the sound from electroacoustic transducer 50. Vibration driver 30 is fixed to housing 20, and vibration of vibration driver 30 reaches housing 20.

Then, the vibration which has reached housing 20 reaches ear pad 40. Ear pad 40 is a structure that is in contact with the skin around the ear and by which vibration is directly transmitted to the auditory nerve, and thus the user may physically feel the vibration while listening to the sound by the eardrum.

### 3. Frequency Characteristics of Vibration by Vibration Driver

Frequency characteristics of vibration that is generated by headphones 100 of the present exemplary embodiment will be described.

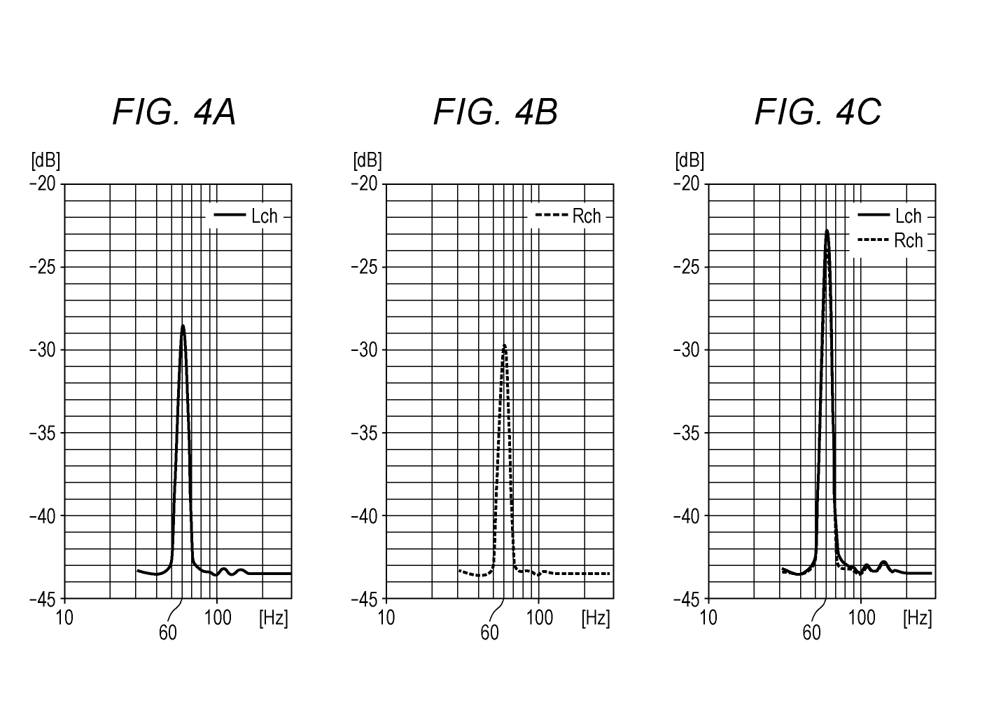

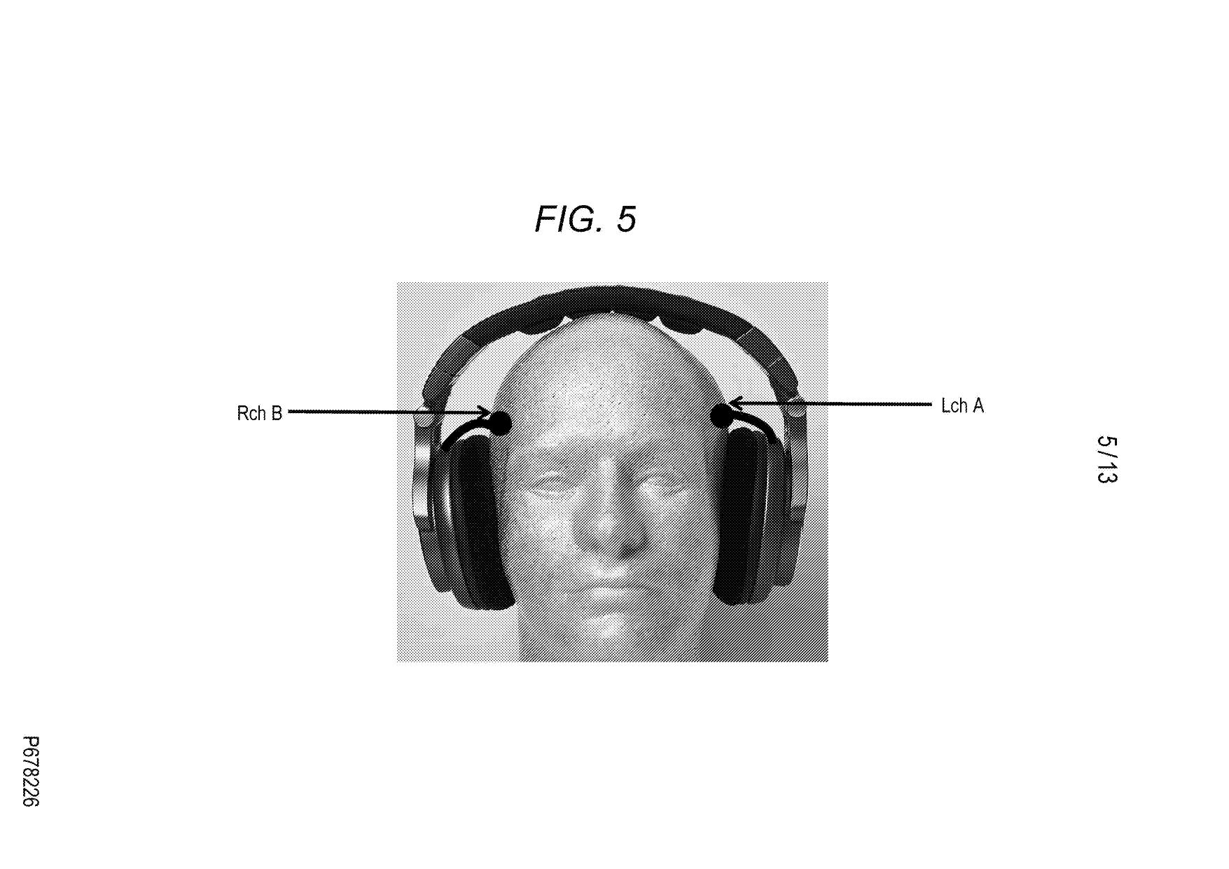

First, frequency characteristics of vibration levels of conventional vibration headphones will be described. FIG. 4A is a diagram showing, with respect to the conventional vibration headphones, frequency characteristics of a vibration level in a case where a signal is fed only to a left channel (Lch). FIG. 4B is a diagram showing, with respect to the conventional vibration headphones, frequency characteristics of a vibration level in a case where a signal is fed only to a right channel (Rch). FIG. 4C is a diagram showing frequency characteristics of vibration levels of the conventional vibration headphones. In FIGS. 4A to 4C, the vertical axis indicates the vibration level, and the horizontal axis indicates the frequency. FIG. 5 is a diagram for describing measurement points for frequency characteristics of vibration levels.

Pieces of data shown in FIGS. 4A to 4C have been obtained by measuring the vibration levels while changing the frequency, by mounting the conventional vibration headphones on a dummy head, as shown in FIG. 5, and attaching acceleration pickups to the measurement points, on the dummy head, for Lch A and Rch B. At this time, the resonant frequencies of springs 31a and 31b embedded in vibration drivers 30a and 30b are set to 60 Hz.

FIG. 4A shows a result of measuring, after a signal is fed only to the Lch, the frequency characteristics of a vibration level at the point of Lch A on the dummy head. As shown in FIG. 4A, the vibration level of Lch peaks at 60 Hz. FIG. 4B shows a result of measuring, after a signal is fed only to the Rch, the frequency characteristics of a vibration level at the point of Rch B on the dummy head. As shown in FIG. 4B, the vibration level of Rch also peaks at 60 Hz.

FIG. 4C shows results of measuring, after signals are fed to both Lch and Rch, the frequency characteristics of a vibration level at each of the points of Lch A and Rch B on the dummy head. As shown in FIG. 4C, the vibration levels of Lch and Rch indicate approximately the same results. Also, the amplitude of the vibration levels is greater compared to a case where only one channel is used, but the frequency characteristics are unchanged and peak at 60 Hz. In this manner, with the conventional vibration headphones, even if signals are fed to both Lch and Rch, the vibration frequency band for transmission to housings 20a and 20b remains narrow. Music sources such as movies and games were actually listened to, and it was found that the video and the vibration did not always link together, and the feel of reality was lacking.

To solve this, vibration driver 30 of headphones 100 according to the present exemplary embodiment is configured in such a way as to widen the vibration frequency band for bone conduction. Specifically, the resonant frequency of spring 31a that is embedded in vibration driver 30a attached to right housing 20a and the resonant frequency of spring 31b that is embedded in vibration driver 30b attached to left housing 20b are made different.

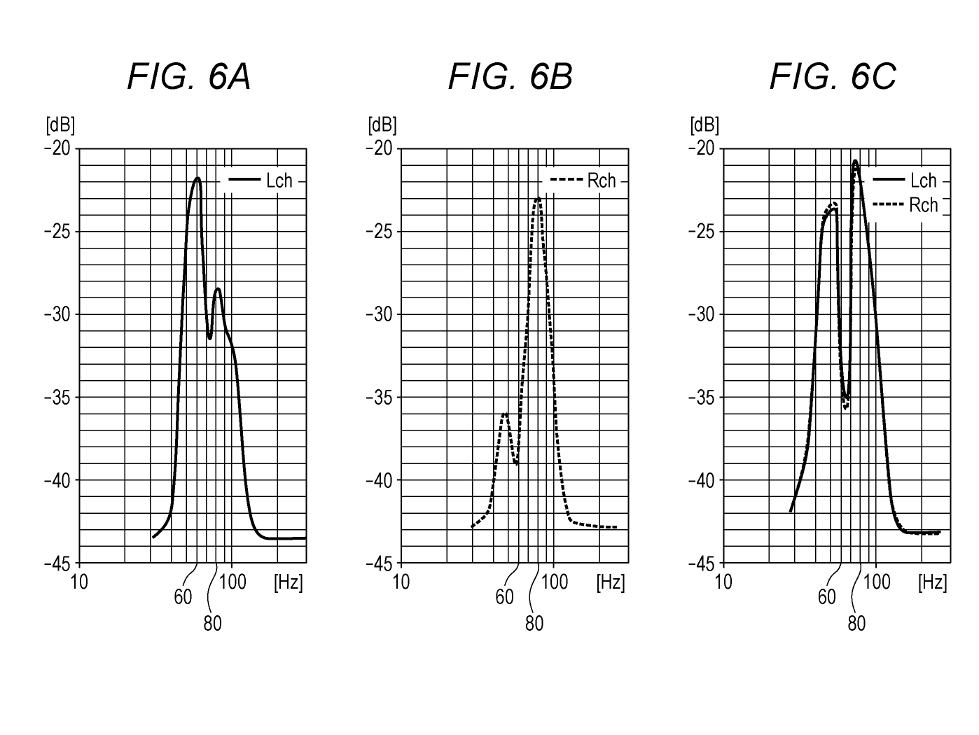

FIG. 6A is a diagram showing, with respect to the vibration headphones according to the first exemplary embodiment, frequency characteristics of a vibration level in a case where a signal is fed only to a left channel. FIG. 6B is a diagram showing, with respect to the vibration headphones according to the first exemplary embodiment, frequency characteristics of a vibration level in a case where a signal is fed only to a right channel. FIG. 6C is a diagram showing frequency characteristics of vibration levels of the vibration headphones according to the first exemplary embodiment. In FIGS. 6A to 6C, the vertical axis indicates the vibration level, and the horizontal axis indicates the frequency.

With headphones 100 according to the present exemplary embodiment, the resonant frequencies of vibration drivers 30a and 30b inside left and right housings 20a and 20b are made different from each other. Pieces of data shown in FIGS. 6A to 6C have been measured by mounting headphones 100 on a dummy head as shown in FIG. 5, and attaching acceleration pickups to the measurement points on the dummy head for Lch A and Rch B.

In this case, the resonant frequency of spring 31a that is embedded in vibration driver 30a at right housing 20a is set to 60 Hz. On the other hand, the resonant frequency of spring 31b that is embedded in vibration driver 30b at left housing 20b is set to 80 Hz.

FIG. 6A shows a result of measuring, after a signal is fed to only Lch, vibration level versus frequency at the point of Lch A on the dummy head. As shown in FIG. 6A, the vibration frequency band is wide for the vibration level of Lch with peaks appearing at 60 Hz and around 80 Hz.

FIG. 6B shows a result of measuring, after a signal is fed to only Rch, vibration level versus frequency at the point of Rch B on the dummy head. As shown in FIG. 6B, the vibration frequency band is wide for the vibration level with peaks appearing at 80 Hz and also at 60 Hz.

FIG. 6C shows results of measuring, after signals are fed to both Lch and Rch, the frequency characteristics of a vibration level at each of the points of Lch A and Rch B on the dummy head. As shown in FIG. 6C, the vibration frequency band is wide for the vibration levels of Lch and Rch with peaks appearing at 60 Hz and 80 Hz. In this case, the vibration levels are about the same at 60 Hz and 80 Hz. In this manner, with the vibration headphones according to the first exemplary embodiment, resonant frequencies are observed at both 60 Hz and 80 Hz for both of the points of Lch A and Rch B. This is because right housing 20a and left housing 20b are linked by hard headband 10a, and the vibration of one housing is transferred to the other housing.

That is, by making the resonant frequencies of vibration drivers 30a, 30b inside left and right housings 20a, 20b different, as in the present exemplary embodiment, there appear two resonant frequencies, and the vibration frequency band is widened. Compared with the conventional configurations shown in FIGS. 4A to 4C, the vibration frequency band according to the present exemplary embodiment is five times wider. When music sources such as movies and games have been actually listened to with headphones 100 of the present exemplary embodiment, the heavy bass sound and the feel of reality were better felt, and the feeling close to that felt in the actual movie theater or a concert venue was experienced, compared to the conventional configurations.

### 4. Example Configuration of Vibration Driver

Hereinafter, specific example configurations of vibration driver 30 used in headphones 100 according to the present exemplary embodiment will be described.

### (A) First Example Configuration

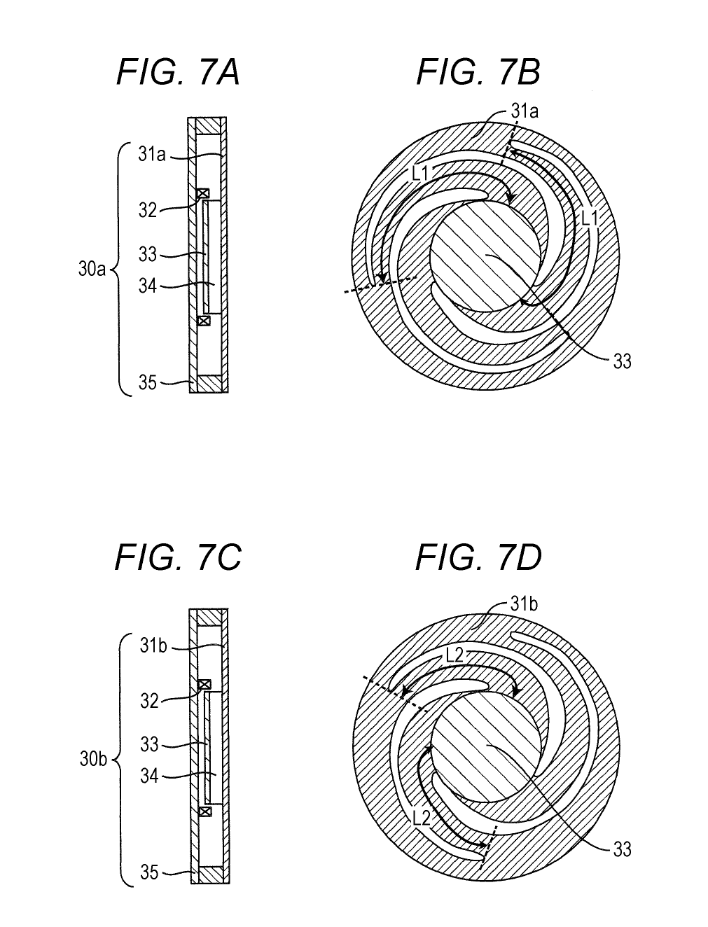

FIGS. 7A to 7D show configurations of vibration drivers 30a, 30b of a first example configuration. FIGS. 7A and 7B are cross-sectional diagrams showing vibration driver 30a of right housing 20a of the first example configuration. FIGS. 7C and 7D are cross-sectional diagrams showing vibration driver 30b of left housing 20b of the first example configuration.

As shown in FIGS. 7B and 7D, according to the first example configuration, the shapes of springs 31a, 31b of left and right vibration drivers 30a, 30b are made different to thereby cause the resonant frequencies of entire left and right vibration drivers 30a, 30b to be different.

Specifically, the lengths of arms of spring 31a that is embedded in vibration driver 30a of right housing 20a and of spring 31b that is embedded in vibration driver 30b of left housing 20b are different between springs 31a, 31b. The resonant frequencies are thereby made different between left and right vibration drivers 30a, 30b.

More specifically, length L2 of the arms of spring 31b in left housing 20b is made shorter than length L1 of the arms of spring 31a in right housing 20a. Thus, the resonant frequency of vibration driver 30a in right housing 20a is made 60 Hz, and the resonant frequency of vibration driver 30b in left housing 20b is made 80 Hz.

### (B) Second Example Configuration

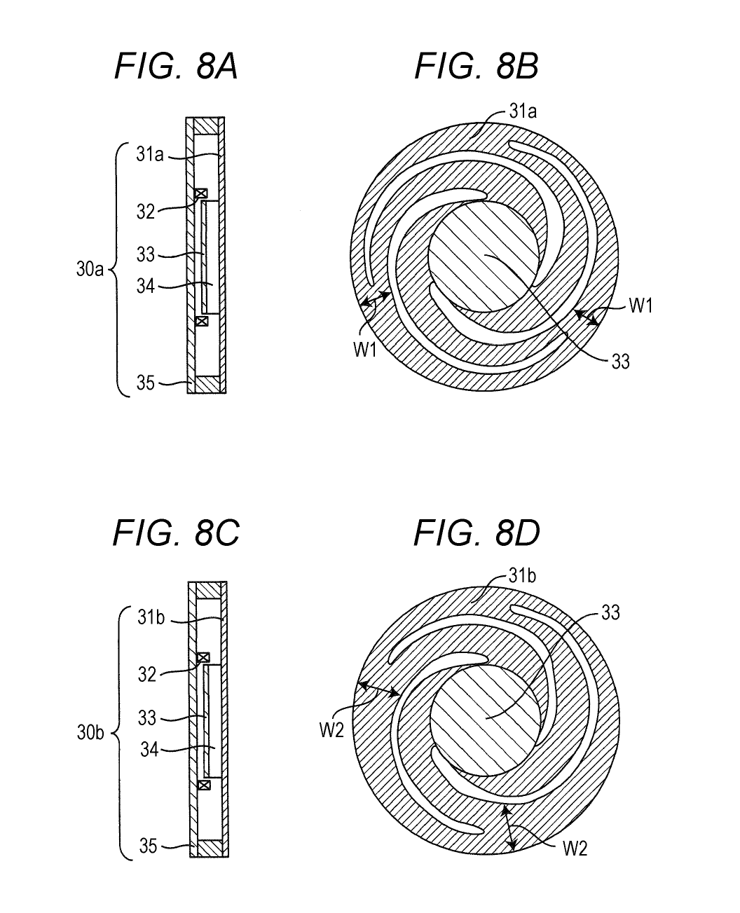

FIGS. 8A to 8D show configurations of vibration drivers 30a, 30b of a second example configuration. FIGS. 8A and 8B are cross-sectional diagrams showing vibration driver 30a of right housing 20a of the second example configuration. FIGS. 8C and 8D are cross-sectional diagrams showing vibration driver 30b of left housing 20b of the second example configuration.

In the second example configuration, the thickness (width) of the arms of spring 31a that is embedded in vibration driver 30a in right housing 20a and of spring 31b that is embedded in vibration driver 30b in left housing 20b are made different between springs 31, and the resonant frequencies are thereby made different between left and right vibration drivers 30a, 30b.

Specifically, thickness (width) W2 of the arms of spring 31b is made thicker than thickness (width) W1 of the arms of spring 31a. Thus, the resonant frequency of vibration driver 30a in right housing 20a is made 60 Hz, and the resonant frequency of vibration driver 30b in left housing 20b is made 80 Hz.

### (C) Third Example Configuration

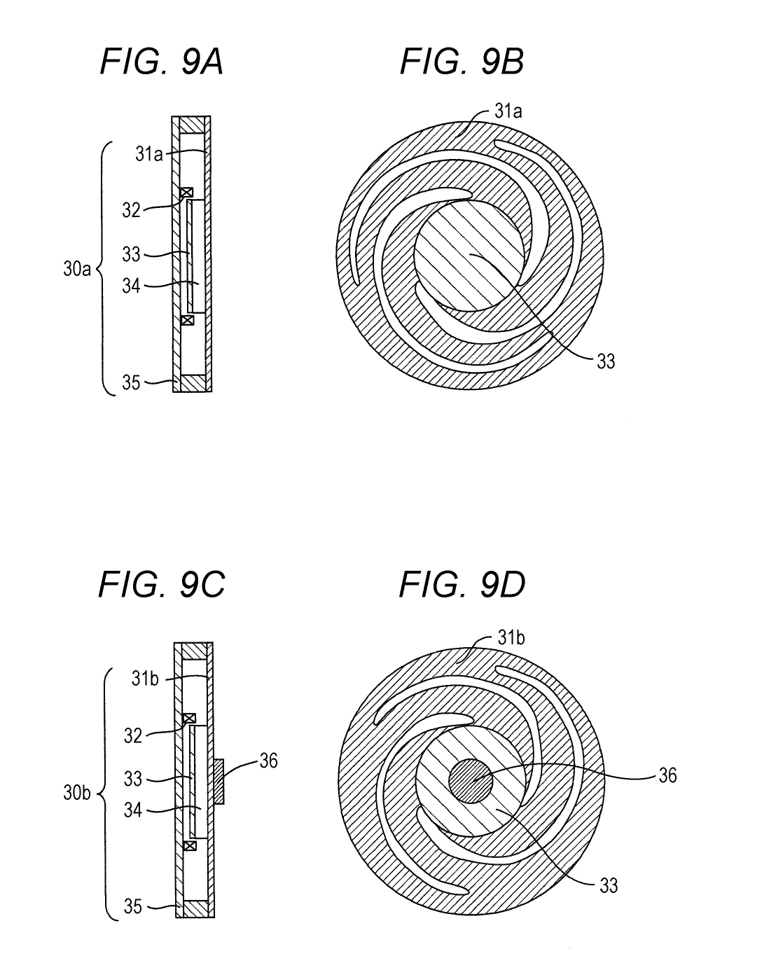

FIGS. 9A to 9D show configurations of vibration drivers 30a, 30b of a third example configuration. FIGS. 9A and 9B are cross-sectional diagrams showing vibration driver 30a of right housing 20a of the third example configuration. FIGS. 9C and 9D are cross-sectional diagrams showing vibration driver 30b of left housing 20b of the third example configuration.

In the third example configuration, the shapes of springs 31a, 31b that are embedded in the vibration drivers attached to housings 20a and 20b of headphones 100 are the same. However, weight 36 is added to left spring 31b. The resonant frequency of left vibration driver 30b is thereby made different from the resonant frequency of right vibration driver 30a. Additionally, any material may be used as the material of weight 36. For example, rubber or iron may be used.

### (D) Fourth Example Configuration

The first to the third example configurations show example configurations where one spring 31 (that is, the vibration driver) has only one resonant frequency, but one spring (that is, the vibration driver) may also have two resonant frequencies. Also in this case, the vibration frequency band of the vibration driver may be widened.

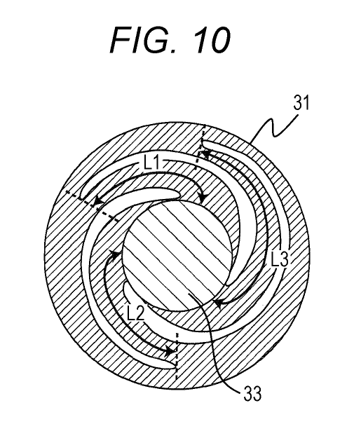

FIG. 10 is a cross-sectional diagram showing a vibration driver of a fourth example configuration. FIG. 10 shows an example configuration of spring 31 having two resonant frequencies. In the first to the third example configurations, the arms of one spring have the same length. On the other hand, in the fourth example configuration, lengths L1, L2 and L3 of the arms of spring 31 are made different.

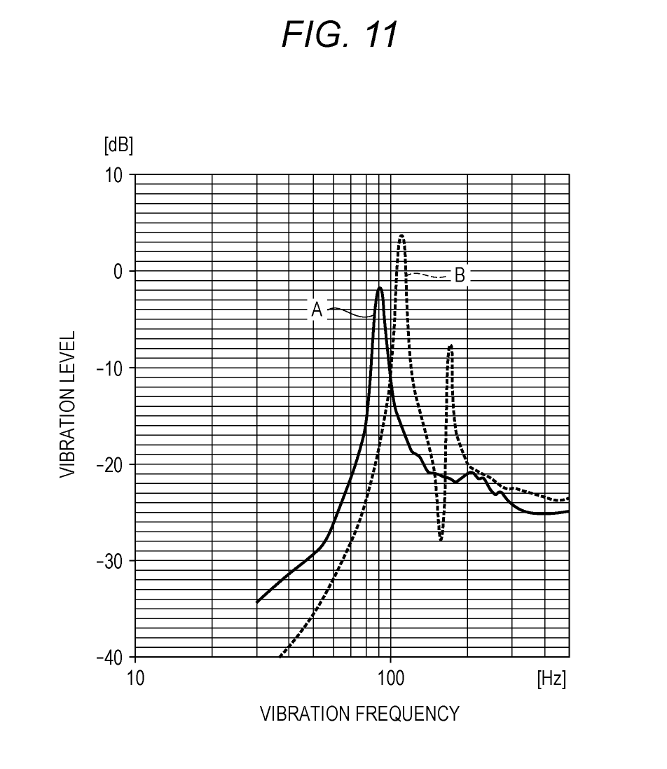

FIG. 11 is a diagram showing frequency characteristics of a vibration level of vibration driver 30 of the fourth example configuration. In FIG. 11, solid line A indicates, as a comparative example, the frequency characteristics of a vibration driver including a spring the lengths of whose arms are the same. A number of peaks of the vibration level indicated by solid line A is one, and thus one resonant frequency is included. Broken line B indicates the frequency characteristics of the vibration driver of the fourth example configuration. There are two peaks in the vibration level indicated by broken line B.

That is, vibration driver 30 of the fourth example configuration has two resonant frequencies. It can be seen that, by modifying the shape of spring 31, a vibration driver may be configured so that one vibration driver has two resonant frequencies, as indicated by broken line B.

### (E) Fifth Example Configuration

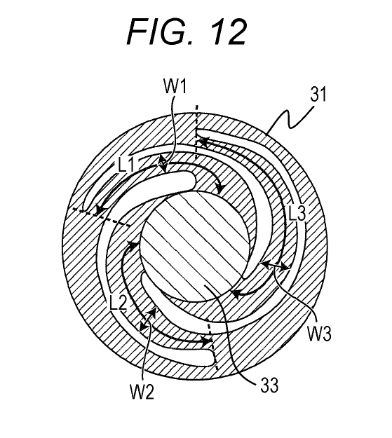

FIG. 12 is a cross-sectional diagram showing a vibration driver of a fifth example configuration. FIG. 12 shows an example configuration of spring 31 having two resonant frequencies. In the fifth example configuration, lengths L1, L2 and L3 and thicknesses (widths) W1, W2 and W3 of the arms of spring 31 take different values.

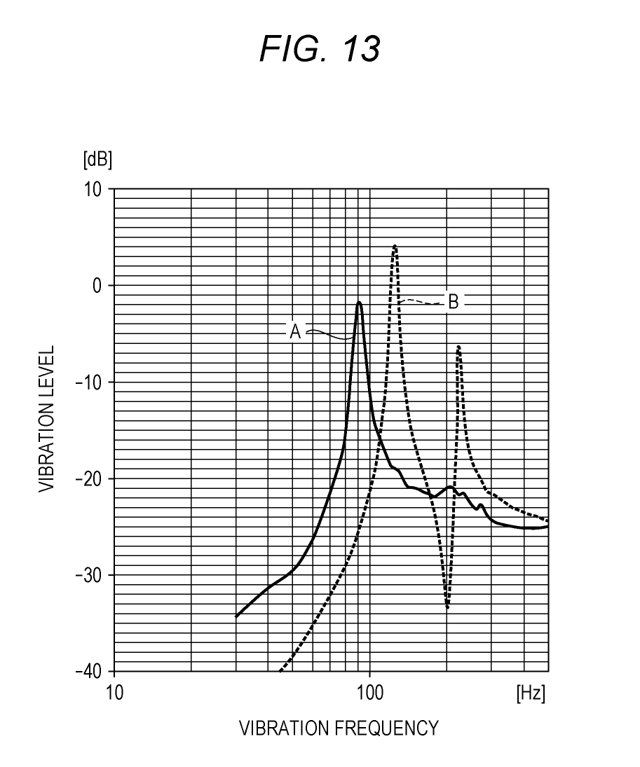

FIG. 13 is a diagram showing frequency characteristics of vibration driver 30 including spring 31 of the fifth example configuration. In FIG. 13, solid line A indicates, as a comparative example, the frequency characteristics of a vibration driver including a spring the lengths and the thicknesses of whose arms are the same. A number of peaks of the vibration level indicated by solid line A is one, and thus one resonant frequency is included. Broken line B indicates the frequency characteristics of the vibration driver including the spring of the fifth example configuration. There are two peaks in the vibration level indicated by broken line B.

That is, vibration driver 30 of the fifth example configuration has two resonant frequencies. It can be seen that, by modifying the shape of spring 31, a vibration driver may be configured so that one vibration driver has two resonant frequencies, as indicated by broken line B.

As indicated by the fourth and the fifth example configurations, by modifying the shape of spring 31, one spring 31 (that is, the vibration driver) may be made to have two resonant frequencies. Accordingly, the vibration frequency band may be widened also by configuring the vibration driver of at least one of left and right housings 20a, 20b to have two resonant frequencies.

Additionally, in the fourth and the fifth example configurations, one vibration driver 30 is made to have two resonant frequencies by modifying the shape of spring 31, but one vibration driver 30 may be made to have two resonant frequencies by modifying other elements. Additionally, in FIGS. 11 and 13, the resonant frequencies exceed 100 Hz, and thus in the fourth and the fifth example configurations, the cut-off frequency of filter 72 has to be set to a value that is higher than 100 Hz.

### 5. Effects, etc.

As described above, headphones 100 according to the present exemplary embodiment include housing 20a including electroacoustic transducer 50a configured to output a sound wave that is generated based on an audio signal in a right channel (an example of a first channel) and vibration driver 30a (an example of a first vibration unit) configured to vibrate by converting an audio signal into mechanical vibration, and housing 20b including electroacoustic transducer 50b configured to output a sound wave that is generated based on an audio signal in a left channel (an example of a second channel) and vibration driver 30b (an example of a second vibration unit) configured to vibrate by converting an audio signal into mechanical vibration.

Resonant frequencies of vibration drivers 30a and 30b are set in such a way that, when both of vibration drivers 30a and 30b vibrate, at least two resonant frequencies appear in vibrations of vibration drivers 30a and 30b.

Headphones 100 as described above may transmit sounds from electroacoustic transducers 50a, 50b to the eardrums of a user, and may transmit, by vibration drivers 30a, 30b, separately from electroacoustic transducers 50, signals of heavy bass sounds to the body (head) of the user as vibrations. The user is thus allowed to physically experience powerful sounds with respect to the heavy base sounds, and to also experience the feel of reality.

Particularly, the vibration frequency band may be widened, as shown in FIG. 6C, due to the resonant frequency of vibration driver 30a of right housing 20a and the resonant frequency of vibration driver 30b of left housing 20b being different, and a user is allowed to physically experience powerful heavy bass sounds and the feel of reality as if viewing/listening in a movie theater or a concert venue.

### Other Exemplary Embodiments

Heretofore, the first exemplary embodiment has been described as an example of the technology disclosed in the present application. However, the technology in the present disclosure is not limited to the above embodiment, and may also be applied to exemplary embodiments which have been subjected to modifications, substitutions, additions, or omissions as required. Moreover, it is also possible to combine other elements to the structural elements described in the first exemplary embodiment to realize new exemplary embodiments. In the following, other exemplary embodiments will be described as examples.

The exemplary embodiment above describes an electromagnetic vibration driver that uses coil 32 and magnet 33, but various structures, such as piezoelectric, electrodynamic, and electrostatic structures, may be adopted as the vibration driver.

In the exemplary embodiment described above, the cut-off frequency of filter (LPF) 72 is 100 Hz, but the cut-off frequency is not limited thereto. The cut-off frequency may be set to a value higher or lower than 100 Hz as appropriate by taking into account the effects of bone conduction.

The values of the resonant frequencies of vibration drivers 30 described in the exemplary embodiment above are only examples, and the resonant frequencies may take other values. For example, the resonant frequencies may take any value within the range of 50 Hz to 100 Hz.

In the exemplary embodiment described above, vibration drivers 30a and 30b are configured in such a way that, when both of vibration drivers 30a and 30b vibrate, two resonant frequencies appear in the vibrations of vibration drivers 30a and 30b, as shown in FIGS. 6C, 11 and 13.

However, a number of resonant frequencies is not limited to two. Vibration drivers 30 may be configured such that there appear three or more resonant frequencies. This is because the vibration frequency band may be widened by causing a plurality of resonant frequencies to appear. In the exemplary embodiment described above, wireless circuit 74 is mounted on electrical circuit 75 to receive audio signals, but the audio signals may be input to headphone amplifier 71 via a signal cable without using wireless circuit 74.

The exemplary embodiment above describes the configuration of spring 31 having three supporting points (arms), but a number of supporting points (arms) may be one or four. That is, springs 31 may be formed to have any shape as long as spring resonance is generated in such a way that left and right housings 20a, 20b have different resonant frequencies.

Heretofore, exemplary embodiments have been described as examples of the technology according to the present disclosure. The appended drawings and the detailed description are provided for this purpose.

Therefore, the structural elements shown in the appended drawings and described in the detailed description include not only structural elements that are essential but also other structural elements in order to illustrate the technology. Hence, that these non-essential structural elements are shown in the appended drawings and described in the detailed description does not cause these structural elements to be immediately recognized as being essential.

Furthermore, since the exemplary embodiments described above are for illustrating the technology according to the present disclosure, various modifications, substitutions, additions, and omissions may be performed within a range of claims and equivalents to the claims.

What is claimed is:

1. Vibration headphones comprising:
a first housing including a first electroacoustic transducer configured to output a sound wave that is generated based on an audio signal fed to a first channel, and a first vibration unit configured to vibrate by converting an audio signal into mechanical vibration; and
a second housing including a second electroacoustic transducer configured to output a sound wave that is generated based on an audio signal in a second channel, and a second vibration unit configured to vibrate by converting an audio signal into mechanical vibration,
wherein resonant frequencies of the first vibration unit and the second vibration unit are set in such a way that, when both the first vibration unit and the second vibration unit vibrate, at least two resonant frequencies appear in vibrations of the first vibration unit and the second vibration unit.

2. The vibration headphones according to claim 1, wherein the resonant frequency of the first vibration unit and the resonant frequency of the second vibration unit are different from each other.

3. The vibration headphones according to claim 1, wherein at least one of the first vibration unit and the second vibration unit has at least two resonant frequencies.

4. The vibration headphones according to claim 1,
wherein the first housing includes a first low-pass filter configured to pass an audio signal having a frequency equal to or lower than a predetermined frequency, and the second housing includes a second low-pass filter configured to pass an audio signal having a frequency equal to or lower than the predetermined frequency, and
wherein the first vibration unit vibrates by converting an audio signal which has passed through the first low-pass filter into mechanical vibration, and the second vibration unit vibrates by converting an audio signal which has passed through the second low-pass filter into mechanical vibration.

5. The vibration headphones according to claim 4, wherein the first and the second low-pass filters block signals having frequencies exceeding 100 Hz.
